(19) United States
(12) Patent Application Publication
(10) Pub. No.: US 2026/0044152 A1
(43) Pub. Date: Feb. 12, 2026

(54) SLOPE MANAGEMENT SYSTEM FOR EQUIPMENT STABILITY

(71) Applicant: G2 Ideation LLC, Cheyenne, WY (US)

(72) Inventor: Kyle Michael Allison, Davidson, NC (US)

(21) Appl. No.: 19/283,659

(22) Filed: Jul. 29, 2025

Related U.S. Application Data
(60) Provisional application No. 63/681,424, filed on Aug. 9, 2024.

(51) Int. Cl. G05D 1/495; G05D 105/05; G05D 105/28

(52) U.S. Cl. CPC G05D 1/495; G05D 2105/05; G05D 2105/28

(57) ABSTRACT

A slope management system and associated method for equipment may control the equipment by preventing operation of the equipment if an actual angle of the equipment relative to level is outside of a slope limit for the equipment. Such equipment includes at least one of an aerial device, a dump truck, a crane, a personnel lift, a digger derrick, a tele-handler, a scissor lift, a forklift, a bucket truck, a wood chipper, a brush chipper, a vacuum truck, a directional drill, a bull dozer, a backhoe, a wheeled loader, a tracked loader, a skid steer, a compact track loader, an excavator, a compactor, a steam roller, a motor grader, a chip truck, a tractor, combinations thereof, and/or as otherwise desired.

### REFERENCE TO RELATED APPLICATION

This application claims the benefit of and priority to U.S. Provisional Ser. No. 63/681,424 , filed on Aug. 9, 2024, and entitled SLOPE MANAGEMENT SYSTEM FOR EQUIPMENT STABILITY, the content of which is hereby incorporated by reference in its entirety.

### FIELD OF THE INVENTION

The invention relates to systems and methods for managing stability of equipment.

### BACKGROUND OF THE INVENTION

Many types of equipment must be properly set up in order to provide stability during use or operation. While ideally such equipment is always positioned on level ground, in reality, equipment is commonly set up and operated on uneven terrain and/or sloped surfaces, and an operator makes the judgment as to whether the equipment is properly set up and stable. Such common approaches are susceptible to operator error. Moreover, if equipment is improperly set up on such sloped surfaces, the equipment may become unstable, potentially falling over, causing damage to the equipment (and/or other equipment), and/or causing injury to one or more operators,

### SUMMARY

Embodiments covered by this patent are defined by the claims below, not this summary. This summary is a high-level overview of various embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a slope management system for equipment may control the equipment by preventing operation of the equipment if an actual angle of the equipment relative to level is outside of a slope limit for the equipment.

In certain embodiments, the equipment may include one or more of an aerial device, a dump truck, a crane, a personnel lift, a digger derrick, a tele-handler, a scissor lift, a forklift, a bucket truck, a wood chipper, a brush chipper, a vacuum truck, a directional drill, a bull dozer, a backhoe, a wheeled loader, a tracked loader, a skid steer, a compact track loader, an excavator, a compactor, a steam roller, a motor grader, a chip truck, a tractor, combinations thereof, and/or as otherwise desired. Additionally, or alternatively, the equipment includes manufacturer-published slope limits and/or predefined slope limits,

According to some embodiments, a slope management system includes one or more processors and a non-transitory computer readable storage medium with instructions, which, when executed by the one or more processors, cause the one or more processors to perform actions. Such actions include, but are not limited to, controlling equipment by preventing operation of the equipment if an actual angle of the equipment relative to level is outside of a slope limit for the equipment.

According to various embodiments, a non-transitory computer readable storage medium includes instructions executable by one or more processors, the instructions including instructions which, when executed by the one or more processors, cause the one or more processors to perform actions such as but not limited to controlling equipment by preventing operation of the equipment if an actual angle of the equipment relative to level is outside of a slope limit for the equipment.

According to certain embodiments, a method of controlling equipment includes preventing operation of the equipment if an actual angle of the equipment relative to level is outside of a slope limit for the equipment.

According to some embodiments, a slope management system for equipment may monitor an actual angle of the equipment relative to level and halt, disrupt, and/or prevent further operation of the equipment in a manner increasing the actual angle if the actual angle of the equipment is outside of a slope limit for the equipment.

According to certain embodiments, a slope management system includes one or more processors and a non-transitory computer readable storage medium with instructions, which, when executed by the one or more processors, cause the one or more processors to perform actions. Such actions include, but are not limited to, monitoring an actual angle of the equipment relative to level, and halting, disrupting, and/or preventing further operation of the equipment in a manner increasing the actual angle if the actual angle of the equipment is outside of a slope limit for the equipment.

According to various embodiments, non-transitory computer readable storage medium includes instructions executable by one or more processors, the instructions including instructions which, when executed by the one or more processors, cause the one or more processors to perform actions including monitoring an actual angle of the equipment relative to level and halting, disrupting, and/or preventing further operation of the equipment in a manner increasing the actual angle if the actual angle of the equipment is outside of a slope limit for the equipment.

According to certain embodiments, a method of controlling equipment includes monitoring an actual angle of the equipment relative to level, and halting, disrupting, and/or preventing further operation of the equipment in a manner increasing the actual angle if the actual angle of the equipment is outside of a slope limit for the equipment.

Various implementations described herein can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The specification makes reference to the following appended figures, in which use of like reference numerals in different figures is intended to illustrate like or analogous components.

FIG. 1 illustrates equipment with a slope management system according to embodiments.

FIG. 2 illustrates a forklift as the equipment of FIG. 1 according to embodiments.

FIG. 3 illustrates the forklift of FIG. 2 on a slope according to embodiments.

FIG. 4 illustrates a dump truck as the equipment of FIG. 1 according to embodiments.

FIG. 5 illustrates a bucket truck as the equipment of FIG. 1 according to embodiments.

FIG. 6 illustrates a scissor lift as the equipment of FIG. 1 according to embodiments.

FIG. 7 illustrates a method of controlling equipment using the slope management system of FIG. 1 according to embodiments.

### DETAILED DESCRIPTION

Described herein are systems and methods for controlling equipment using a slope management system. In certain embodiments, the slope management system may prevent operation of the equipment outside of slope limits for the equipment.

The equipment utilizing the slope management system described herein may be various types of equipment as desired. In certain embodiments, the equipment utilizing the slope management system may be equipment with slope limits defined (e.g., by a manufacturer and/or set by a customer, user, owner, etc.) for safe and/or stable operation of the equipment, As non-limiting examples, equipment utilizing the slope management system described herein may include, but is not limited to, aerial devices, dump trucks, cranes, personnel lifts, digger derricks, tele-handlers, scissor lifts, bucket trucks, forklifts, wood chippers, brush chippers, cement trucks, vacuum trucks, directional drills, bull dozers, backhoes, wheeled loaders, tracked loaders, skid steers, compact track loaders, excavators, compactors, steam rollers, motor graders, chip trucks, tractors, combinations thereof, and/or other equipment as desired. In some embodiments, the equipment may be provided with the slope management system as a native or OEM component, while in other embodiments, the slope management system described herein may be retrofit and/or otherwise provided separately to the equipment.

According to various embodiments, the slope management system described herein may prevent operation of the equipment if the slope limit of the equipment is exceeded in any direction relative to level (e.g., flat or horizontal ground), Additionally, or alternatively, the slope management system described herein may control the equipment depending on whether the equipment is being set up and/or initially operated or if the equipment is being operated. In some embodiments, if the equipment is being set up and/or initially operated, the slope management system may prevent operation of the equipment if the slope limit of the equipment is exceeded in any direction relative to level.

In various embodiments, if the equipment is being operated, the slope management system may detect and/or receive a change in slope and perform one or more control responses based on the changed slope exceeding the slop limit and/or approaching a slope limit. Optionally, the system may provide an alert to an operator or user that the slope limit has been exceeded. In one non-limiting example, a control response may include allowing an opportunity to correct the slope. As non-limiting examples, the system may provide a time-out period to correct the slope, after which the slope management system may prevent further operation of the equipment. Additionally, or alternatively, the system may provide a directional or movement limit, such as only allowing movement that improves the slope while preventing movement that worsens the slope. Other controls may be implemented as desired. In another non-limiting example, a control response may include controlling and/or limiting operation of the equipment, such as by allowing for operation of the equipment that may improve the slope but preventing further operation of the equipment that may worsen the slope. In another non-limiting example, a control response may include controlling a speed of operation of the equipment based on the equipment approaching and/or exceeding the slope limit, such as by slowing down movement and/or operation of the equipment to allow for improvement to the slope.

In various embodiments, the slope limit may be set or provided by a manufacturer (e.g., predefined), and/or the slope limit may be defined by a customer, user, and/or owner. The slope management system may receive and/or obtain the slope limit for a particular piece of equipment via various means or mechanisms as desired, such as but not limited to via operator input, based on installation, by automatically by connecting to a third party source, combinations thereof, and/or as otherwise desired,

In some embodiments, the slope management system itself may receive, measure, detect, and/or determine an actual slope or angle of the equipment relative to level and may then provide the functional ability to prevent equipment operation if the angle exceeds the slope limit. In embodiments where the slope management system measures, detects, and/or determines the actual slope or angle of the equipment, the slope management system may include various devices or components suitable for reading or calculating the angle of the equipment relative to level, such as but not limited to position sensors, tilt sensors, multi-axis tilt sensors, bubble tilt sensors, accelerometers, optical sensors, combinations thereof, and/or as otherwise desired.

The slope management system may actively and/or passively prevent or control operation of the equipment outside of the slope limits. As non-limiting examples, the slope management system may send a control signal and/or actively halt, disrupt, prevent, and/or interrupt operations electrically, mechanically, pneumatically, combinations thereof, and/or as otherwise desired. In some embodiments, the slope management system may prevent operation of the equipment if the slope limit of the equipment is exceeded during set up or installation of the equipment. Additionally, or alternatively, the slope management system may monitor the actual slope or angle of the equipment during operation, and may halt, interrupt, disrupt, and/or prevent further operation of the equipment if the angle of the equipment exceeds the slope limit during operation. Optionally, the slope management system may prevent operation of the equipment in a manner increasing the actual angle while enabling a corrective operation of the equipment in a manner decreasing the actual angle. Optionally, the slope management system may enable full operation of the equipment if the actual angle of the equipment is at or within the slope limit. In embodiments where the equipment includes the set up of components in addition to the equipment (e.g., the equipment utilizes outriggers, stabilizers, combinations thereof, etc.), the slope management system may prevent operation if the slope limit is exceeded following the deployment of the outriggers and/or other equipment setup components.

Optionally, the slope management system may generate additional output at various stages of controlling the equipment. As non-limiting examples, the slope management system may provide a status update and/or real-time slope alert (e.g., on a display, via audio, via text, combinations thereof, etc.), optionally comparing and/or illustrating an actual angle and/or the slope limit. As a further non-limiting example, the slope management system may provide an alert, alarm, light, combinations thereof, and/or other system and/or device providing an operator interface, optionally to indicate that the slope management system is operational, the slope limit is reached, and/or a status of the equipment.

Compared to traditional approaches which rely on operator judgement, the slope management system described herein may improve control of equipment by limiting operation to stable set ups of the equipment defined by the slope limits. Such improved control may improve safety at a worksite by preventing operation of the equipment in unstable configurations, thereby reducing injury or damage to personnel and/or equipment due to the equipment falling over, slipping, etc. Various other benefits and advantages may be realized with the systems and methods described herein, and the aforementioned benefits and advantages should not be considered limiting.

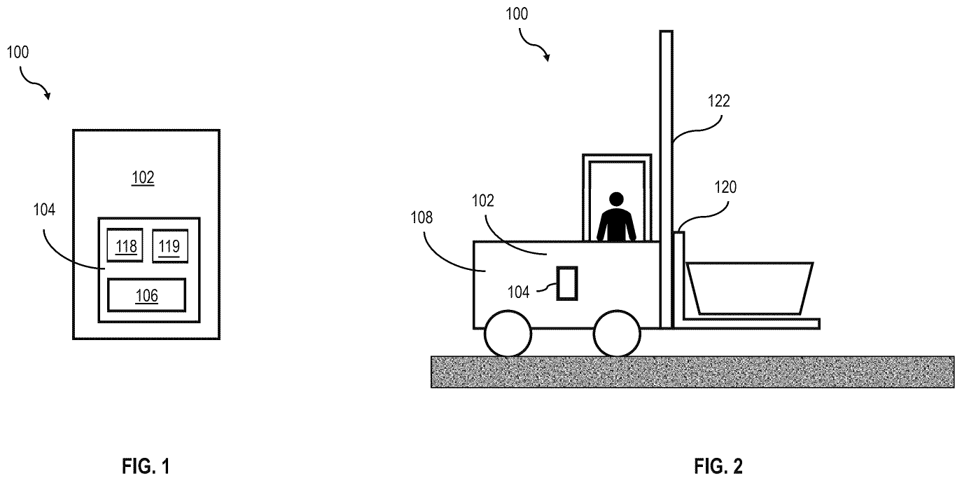

FIGS. 1-6 illustrate an example of an equipment system 100 according to embodiments. The equipment system 100 generally includes a piece of equipment 102 and a slope management system 104 on, in, and/or otherwise associated with the piece of equipment 102. The slope management system 104 may be provided natively with the equipment 102 (e.g., as an OEM part) and/or retrofit and/or otherwise added to the equipment 102 as desired. As discussed in detail below, the slope management system 104 may prevent and/or control operation of the equipment 102 when a slope limit of the equipment 102 is exceeded.

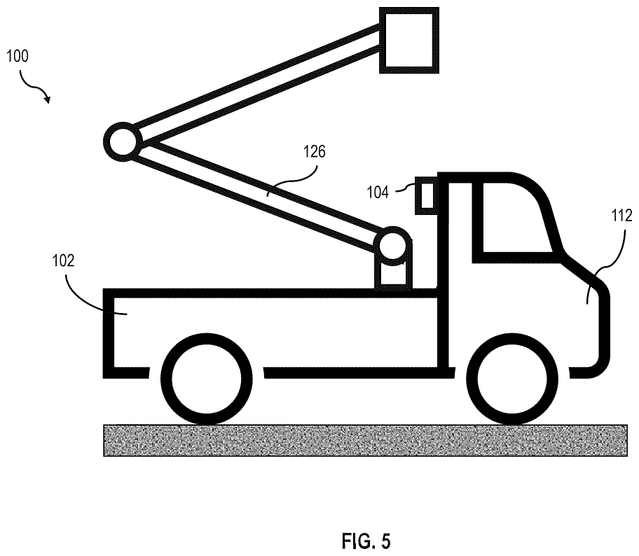

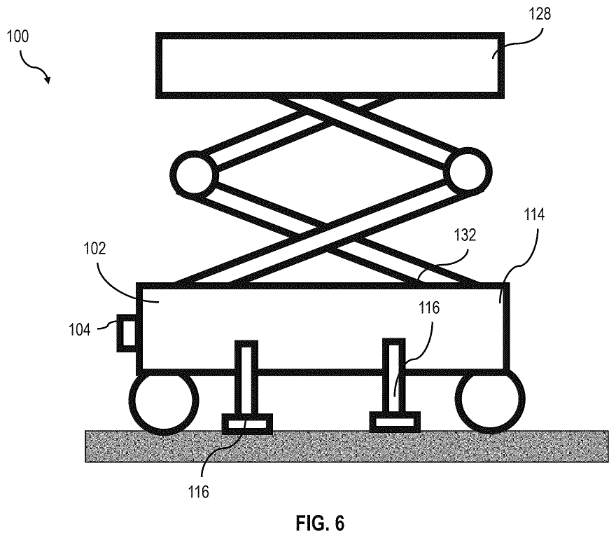

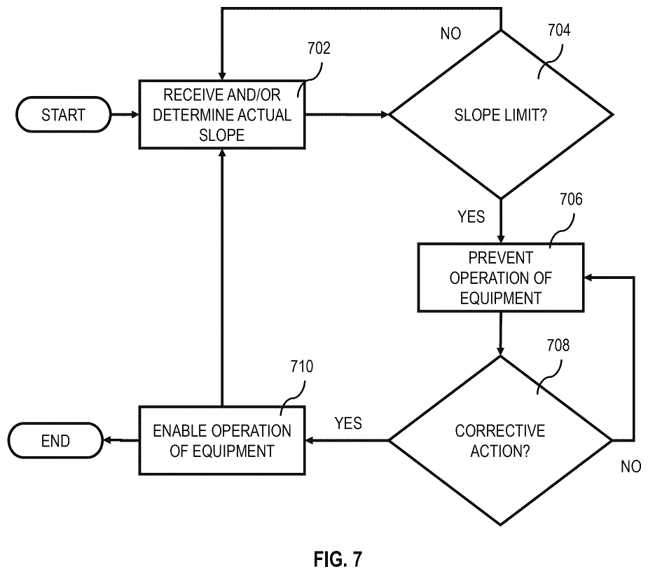

The equipment 102 may be various types of equipment 102 as desired, and the particular equipment 102 illustrated should not be considered limiting. As non-limiting examples, the equipment 102 may be a forklift 108 (see, e.g., FIGS, 2 and 3), a dump truck 110 (see, e.g., FIG. 4), a bucket truck 112 (see, e.g., FIG. 5), a scissor lift 114 (see, e.g., FIG. 6), aerial devices, cranes, personnel lifts, digger derricks, tele-handlers, wood chippers, brush chippers, vacuum trucks, directional drills, bull dozers, backhoes, wheeled loaders, tracked loaders, skid steers, compact track loaders, excavators, compactors, steam rollers, motor graders, chip trucks, tractors, combinations thereof, and/or other equipment as desired. Optionally, the equipment 102 may include one or more set up components, such as but not limited to one or more outriggers 116 (see, e.g., FIG. 6). In certain embodiments, the equipment 102 includes slope limits, or the steepest incline that is acceptable for operation. Such slope limits may be defined and/or predetermined, such as but not limited by a manufacturer of the particular piece of equipment and/or by the customer, owner, and/or user of the equipment. In various embodiments, the slope limits may be defined in a single axis, multi-axis, a plane, and/or as otherwise desired. As such, reference to slope limits refers to a slope relative to level in at least one direction.

The slope management system 104 may include a control system 106 with one or more processing units and/or one or more memory devices. The processing unit may be various suitable processing devices or combinations of devices including but not limited to one or more application specific integrated circuits, digital signal processors, digital signal processing devices, programmable logic devices, field programmable gate arrays, processors, controllers, micro-controllers, microprocessors, other electronic units, and/or a combination thereof. The one or more memory devices may be any machine-readable medium that can be accessed by the processor, including but not limited to any type of long term, short term, volatile, nonvolatile, or other storage medium, and is not to be limited to any particular type of memory or number of memories, or type of media upon which memory is stored. Moreover, as disclosed herein, the term “storage medium,” “storage” or “memory” can represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to, portable or fixed storage devices, optical storage devices, wireless channels, and/or various other storage mediums capable of storing that contain or carry instruction(s) and/or data.

In certain embodiments, the slope management system 104 optionally includes an associated user interface, including but not limited to a graphical user interface or a human machine interface, such that the slope management system 104 may obtain information from a user and/or provide information to the user. In such embodiments, the user interface and/or human machine interface may be on the control system 106 itself, on the equipment 102, and/or may be at a location remote from the control system 106,

The control system 106 may be provided at various locations on, in, or associated with the equipment 102, and the particular locations of the control system 106 illustrated should not be considered limiting. As non-limiting examples, the control system 106 may be provided natively and/or as an OEM component of the equipment 102, optionally included as a component of a broader control system of the equipment 102. Additionally, or alternatively, the control system 106 may be a device, component, or system retrofit and/or otherwise provided separately with the equipment 102.

Optionally, the slope management system 104 includes one or more slope sensors 118 configured to measure and/or detect an angle of the equipment 102 relative to level, and the control system 106 may be communicatively connected to the one or more slope sensors 118 such that the control system receives the measured and/or detected angle of the equipment 102. In some embodiments, the one or more slope sensors 118 may measure and/or detect the angle of the equipment 102 during set up of the equipment 102 and/or during operation of the equipment 102. The slope sensors 118 may be various devices or systems as desired, such as but not limited to position sensors, tilt sensors, multi-axis tilt sensors, bubble tilt sensors, accelerometers, optical sensors, combinations thereof, and/or as otherwise desired. In other embodiments, the slope management system 104 need not include the one or more slope sensors 118, and the slope management system 104 may obtain and/or receive angle information from other devices or systems of the equipment 102.

The control system 106 of the slope management system 104 may be communicatively and/or operably connected to various components of the equipment 102 such that the slope management system 104 provides the functional ability to prevent and/or control operation (actively and/or passively) of the equipment. In certain embodiments, and as discussed in detail below, the slope management system 104 may prevent and/or control operation of the equipment responsive to an angle of the equipment 102 (e.g., as detected by the slope sensors 118 and/or determined by the control system 106) exceeding a slope limit for the equipment 102. As used herein, preventing and/or controlling operation of the equipment may refer to both preventing and/or controlling operation of the entire piece of equipment (e.g., in the case of a wood chipper, a brush chipper, etc.) or preventing and/or controlling operation of a component of the equipment that is movable relative to a nominal base during normal operation (e.g., a carriage, a dump bed, a boom, scissor arms, etc.),

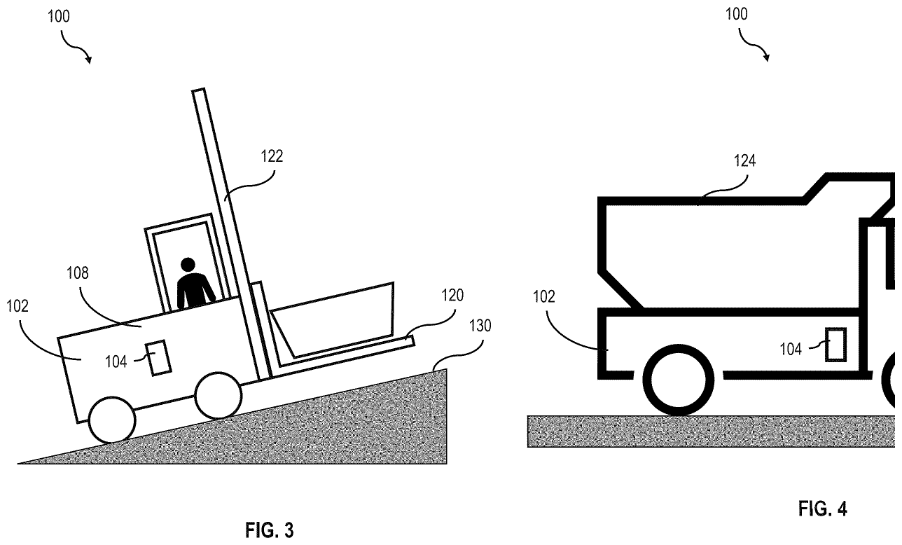

As non-limiting examples, the slope management system 104 may be communicatively and/or operably connected to one or more controllers or control systems of the equipment 102, actuators or actuation systems of the equipment 102, drivers or drive systems of the equipment 102, combinations thereof, and/or as otherwise desired. As a non-limiting example, and referring to FIGS. 2 and 3, the control system 106 may be communicatively and/or operably connected to components of the forklift 108 for selectively preventing and/or controlling raising and/or lowering of a carriage 120 along a mast 122. As another non-limiting example, and referring to FIG. 4, the control system 106 may be communicatively and/or operably connected to components of the dump truck 110 for selectively preventing and/or controlling raising and/or lowering of a dump bed or box 124. As another non-limiting example, and referring to FIG. 5, the control system 106 may be communicatively and/or operably connected to components of the bucket truck 112 for selectively preventing and/or controlling raising and/or lowering of a boom 126. As yet another non-limiting example, and referring to FIG. 6, the control system 106 may be communicatively and/or operably connected to components of the scissor lift 114 for selectively preventing and/or controlling raising and/or lowering of a platform 128. Various other controls may be implemented as desired, and the aforementioned examples should not be considered limiting.

FIG, 7 illustrates a method of controlling equipment 102 using the slope management system 104. While the method is discussed in the context of the forklift 108 as the equipment, the method is equally applicable in other equipment 102 as desired.

In a block 702, the method includes receiving and/or determining an actual slope or angle of the equipment 102 relative to level. In some embodiments, block 702 includes receiving angle information detected by the one or more slope sensors 118. Additionally, or alternatively, block 702 may include receiving angle information from other systems and/or components of the equipment 102. In various embodiments, receiving angle information may include receiving the actual angle of the equipment as measured by the slope sensors 118 and/or other equipment and/or may include receiving information that the control system 106 analyzes to determine an actual angle of the equipment 102. As non-limiting examples, in FIG. 2, the slope management system 104 may determine that the angle of the forklift 108 relative to horizontal is 0°, and in FIG. 3, the slope management system 104 may determine that the angle of the forklift 108 relative to horizontal is 30°. In embodiments where the equipment 102 includes additional set up components (e.g., such as but not limited to one or more outriggers 116 in FIG. 6), block 702 may be performed after the outriggers 116 and/or other set up components have been deployed.

In a block 704, the method includes determining whether a slope limit of the equipment 102 is exceeded. In certain embodiments, block 704 includes comparing the actual angle obtained in block 702 with the slope limit for the equipment, which may be provided to the slope management system 104 and/or otherwise obtained by the slope management system 104 as desired, As a non-limiting example, and referring to FIGS. 2 and 3, the forklift 108 may have a slope limit of 20°above level (e.g., as set by the manufacturer or by an owner), and block 704 includes comparing the actual angle of the forklift 108 (e.g., the angle of 0°in FIG. 2 and the angle of 30°in FIG. 3) to the 20°slope limit.

In various embodiments, if the actual angle of the equipment 102 is less than or equal to the slope limit, the process may return to block. 702. As a non-limiting example, in FIG. 2, the actual angle (0°) obtained in block 702 is less than the slope limit (20°), and the process may return to block 702.

In certain embodiments, if the actual angle of the equipment 102 is greater than the slope limit, the process proceeds to block 706, and the slope management system 104 prevents and/or controls operation of the equipment 102. As a non-limiting example, in FIG. 3, the actual angle (30°) obtained in block 702 is greater than the slope limit (200), and the slope management system 104 prevents raising of the carriage 120 along the mast 122. Additionally, or alternatively, in block 706, the system may allow a corrective action to be performed and/or control the equipment such that the slope may be corrected.

In some embodiments, blocks 702-706 may be performed during set up of the equipment 102 and/or before operation of the equipment 102 (and/or a component thereof) (e.g., the angle may be a first measured angle and/or detected before further operation of the equipment).

Additionally, or alternatively, blocks 702-706 may be performed during operation of the equipment 102 (and/or a component thereof). In various embodiments, if the equipment is being operated, the slope management system may detect and/or receive a change in slope and perform one or more control responses based on the changed slope exceeding the slop limit and/or approaching a slope limit. In one non-limiting example, a control response may include allowing an opportunity to correct the slope (e.g., by providing a time-out period to correct the slope, after which the slope management system may prevent further operation of the equipment) and optionally providing an alert to an operator or user that the slope limit has been exceeded. In another non-limiting example, a control response may include controlling and/or limiting operation of the equipment, such as by allowing for operation of the equipment that may improve the slope but preventing further operation of the equipment that may worsen the slope. In another non-limiting example, a control response may include controlling a speed of operation of the equipment based on the equipment approaching and/or exceeding the equipment, such as by slowing down movement and/or operation of the equipment to allow for improvement to the slope.

As a non-limiting example and referring to FIG. 2, the slope management system 104 may allow the carriage 120 to be raised along the mast 122 when the forklift 108 is at an initial angle less than the slope limit, and may monitor the forklift 108 with the raised mast 122 as the forklift 108 angle transitions to a different angle (e.g., closer to the slope limit as shown in FIG. 3). In this example, the slope management system 104 may prevent further forward movement of the forklift 108 and/or other movement increasing the actual angle of the equipment 102.

Optionally, the process may enable and/or allow a corrective action and/or operation decreasing the actual angle of the equipment 102 if the actual angle of the equipment 102 is outside of the slope limit. As non-limiting examples, the process may enable and/or allow for a corrective action to be implemented, enable and/or allow for an action that improves the slope while preventing an action that worsens the slope, enable and/or allow for slowing down of the speed of operation of the equipment based on the slope approaching and/or exceeding the slope limit, combinations thereof, and/or as otherwise desired. As a non-limiting example, in FIG. 3, the slope management system 104 may allow the forklift 108 to back down the sloped surface 130. Additionally, or alternatively, the slope management system 104 may allow the carriage 120 to be lowered if the carriage 120 is in a raised position, Other corrective actions may be implemented (actively or passively) as desired and/or depending on the equipment 102 as desired.

In such optional embodiments, in a block 708, the process may determine whether the corrective action has been implemented. Determining whether the corrective action has been implemented may include determining whether the actual angle is at or below the slope limit. Optionally, block 708 may include a time limit for implementing the corrective action before the slope management system prevents further operation of the equipment. Optionally, the process may include returning to block 706 if the corrective action has not been implemented and/or if the actual angle of the equipment 102 exceeds the slope limit.

In an optional block 710, the process may enable operation of the equipment 102 upon the implementation of the corrective action and the actual angle of the equipment 102 being at or less than the slope limit.

The aforementioned process is for illustrative purposes, and other processes may be implemented and/or with other types of equipment as desired.

As a non-limiting example, and referring to FIG. 4, the process may include determining an actual angle of the dump truck 110 relative to level and preventing operation of the dump box 124 and preventing operation (e.g., raising or deployment) of the dump box 124 if the actual angle exceeds a slope limit of the dump truck 110 and/or controlling the operation of the dump box 124 such that the slope can only improve.

As another non-limiting example, and referring to FIG. 5, the process may include determining an actual angle of the bucket truck 112 relative to level and preventing operation (e.g., raising or deployment) of the boom 126 if the actual angle exceeds a slope limit of the bucket truck 112 and/or controlling the operation of the bucket truck 112 such that the slope can only improve.

As another non-limiting example, and referring to FIG. 6, the process may include determining an actual angle of the scissor lift 114 relative to level and preventing operation (e.g., raising or deployment) of scissor arms 132 for raising and/or deploying the platform 128 and/or controlling the operation of the scissor lift 114 such that the slope can only improve.

Optionally, in addition to controlling the equipment 102, the slope management system 104 may generate and/or provide various additional outputs as desired. As non-limiting examples, the slope management system 104 may generate an alert (e.g., visual, auditory, text, graphic, etc.) on a user interface and/or may communicate with a remote device or system and provide information on components such as but not limited to a display, speaker, user device, etc. with one or more of a status of the actual slope of the equipment 102, a status of the slope management system 104, and/or an indication that the equipment 102 is above and/or below a slope limit for the equipment, combinations thereof, and/or other information as desired. As a further non-limiting example, the slope management system 104 may change a characteristic of an output device based on various stages of the process as desired. As non-limiting examples, the slope management system 104 may cause a light to be a first color (e.g., green) and/or first pattern (e.g., solid/without blinking) indicating that the slope management system is active and/or the equipment 102 is within the slope limit and a second color (e.g., red) and/or a second pattern (e.g., blinking) indicating that the slope management system is active and the equipment 102 is at an angle exceeding the slope limit.

In some embodiments, the slope management system 104 may communicate information with a telematics device or system (or other external system). In certain embodiments, the telematics device or system may generate various information to a user and/or perform various supplemental operations, such as but not limited to generating one or more reports, generating one or more logs, generating one or more logs, track operation of the equipment, track location of the equipment, tracking status of equipment, combinations thereof, and/or information as desired. The information from slope management system may include, but is not limited to, one or more of system readings, sensor information, current angle of the equipment, historical angle of the equipment, historical operation of the equipment, combinations thereof, and/or other information as desired about the equipment. In some embodiments, the telematics device or system communicatively coupled to the slope management system may be utilized for management of a fleet of equipment, insurance, logistics, safety, and/or asset tracking, combinations thereof, and/or other uses as desired.

Various other outputs may be generated and/or otherwise provided by the slope management system 104 as desired, and the aforementioned examples should not be considered limiting.

Optionally, in addition to slope sensors 118, the slope management system 104 may include one or more orientation and/or terrain sensors 119, In such embodiments, the terrain sensors 119 may measure and/or detect the slope of the terrain and/or the orientation of the equipment 102. Optionally, the control system 106 may provide a terrain alert and/or an orientation alert. Optionally, the control system 106 may control and/or prevent operation of the equipment 102 based on information from both the slope sensors 118 and the terrain sensors 119. As a non-limiting example, depending on the type of equipment 102, it may be possible for an operator to make the equipment 102 appear level on terrain that is otherwise unsuitable and/or unsafe to operate the equipment on (e.g., a steep hill or other terrain). In such embodiments, the terrain sensors 119 may detect or measure the angle of the terrain of the equipment 102, optionally while the equipment 102 is approaching and/or travelling on the terrain (e.g., before set up). As a non-limiting example, a terrain sensor 119 may sense that the forklift 108 is pulling up on a slope and/or an angle of approach of the forklift 108. Optionally, the control system 106 may prevent initial operation or set up of the equipment 102 based on the terrain sensor 119 indicating an unsuitable terrain.

Various other benefits and advantages may be realized with the systems and methods described herein, and the aforementioned benefits and advantages should not be considered limiting,

A collection of exemplary embodiments is provided below, including at least some explicitly enumerated as an “Example” providing additional description of a variety of example embodiments in accordance with the concepts described herein, These examples are not meant to be mutually exclusive, exhaustive, or restrictive; and the disclosure not limited to these examples but rather encompasses all possible modifications and variations within the scope of the issued claims and their equivalents.

Example 1. A slope management system for equipment, wherein the slope management system is configured to control the equipment by preventing operation of the equipment if an actual angle of the equipment relative to level is outside of a slope limit for the equipment.

Example 2. The slope management system, method, or instructions of any preceding or subsequent example or combination of examples, wherein the slope management system is configured to receive the actual angle of the equipment from an external source.

Example 3. The slope management system, method, or instructions of any preceding or subsequent example or combination of examples, wherein the external source comprises at least one of a sensor on the equipment or another system of the equipment.

Example 4. The slope management system, method, or instructions of any preceding or subsequent example or combination of examples, wherein the slope management system is configured to determine the actual angle of the equipment.

Example 5. The slope management system, method, or instructions of any preceding or subsequent example or combination of examples, wherein the slope management system is configured to prevent operation of the equipment by sending a control signal to one or more control devices of the equipment.

Example 6. The slope management system, method, or instructions of any preceding or subsequent example or combination of examples, wherein the slope management system is further configured to provide a supplemental output if the actual angle of the equipment relative to level is outside of the slope limit for the equipment.

Example 7. The slope management system, method, or instructions of any preceding or subsequent example or combination of examples, wherein the slope management system is configured to output information to a telematics device as the supplemental output, and wherein the telematics device is configured to generate a report, log, alert, and/or other information based on the information obtained from the slope management system.

Example 8. The slope management system, method, or instructions of any preceding or subsequent example or combination of examples, wherein the information obtained from the slope management system by the telematics device comprises one or more of system readings, sensor information, current angle of the equipment, historical angle of the equipment, historical operation of the equipment, combinations thereof, and/or other information as desired,

Example 9. The slope management system, method, or instructions of any preceding or subsequent example or combination of examples, wherein the supplemental output comprises at least one of an alert, an alarm, a light, or a display.

Example 10. The slope management system, method, or instructions of any preceding or subsequent example or combination of examples, further comprising a user interface.

Example 11. Equipment comprising the slope management system, method, or instructions of any preceding or subsequent example or combination of examples.

Example 12. The slope management system, method, or instructions of any preceding or subsequent example or combination of examples, wherein the slope management system is native with the equipment.

Example 13. The slope management system, method, or instructions of any preceding or subsequent example or combination of examples, wherein the slope management system is retrofit to the equipment.

Example 14. The slope management system, method, or instructions of any preceding or subsequent example or combination of examples, wherein the equipment comprises at least one of an aerial device, a dump truck, a crane, a personnel lift, a digger derrick, a tele-handler, a scissor lift, a forklift, a bucket truck, a wood chipper, a brush chipper, a vacuum truck, a directional drill, a bull dozer, a backhoe, a wheeled loader, a tracked loader, a skid steer, a compact track loader, an excavator, a compactor, a steam roller, a motor grader, a chip truck, a tractor, combinations thereof, and/or as otherwise desired.

Example 15. The slope management system, method, or instructions of any preceding or subsequent example or combination of examples, wherein the equipment comprises manufacturer-published slope limits or user-defined slope limits.

Example 16. A slope management system comprising: one or more processors; and a non-transitory computer readable storage medium comprising instructions, which, when executed by the one or more processors, cause the one or more processors to perform actions comprising: controlling equipment by preventing operation of the equipment if an actual angle of the equipment relative to level is outside of a slope limit for the equipment.

Example 17. The slope management system, method, or instructions of any preceding or subsequent example or combination of examples, wherein the instructions further comprise instructions, which, when executed by the one or more processors, cause the one or more processors to perform actions comprising at least of: receiving the actual angle of the equipment; or determining the actual angle of the equipment.

Example 18. The slope management system, method, or instructions of any preceding or subsequent example or combination of examples, wherein the instructions further comprise instructions, which, when executed by the one or more processors, cause the one or more processors to perform actions comprising: generating a supplemental output if the actual angle of the equipment relative to level is outside of the slope limit for the equipment.

Example 19. The slope management system, method, or instructions of any preceding or subsequent example or combination of examples, wherein the instructions further comprise instructions, which, when executed by the one or more processors, cause the one or more processors to perform actions comprising: generating an alert, an alarm, a light, or a display as the supplemental output.

Example 20. The slope management system, method, or instructions of any preceding or subsequent example or combination of examples, wherein the instructions further comprise instructions, which, when executed by the one or more processors, cause the one or more processors to perform actions comprising: displaying a status of the slope management system on a display.

Example 21. The slope management system, method, or instructions of any preceding or subsequent example or combination of examples, wherein the slope management system is configured to prevent operation of the equipment if the actual angle of the equipment relative to level is outside of a slope limit for the equipment and is a measured angle of the equipment obtained prior to operation of the equipment.

Example 22. A non-transitory computer readable storage medium comprising instructions executable by one or more processors, the instructions comprising instructions which, when executed by the one or more processors, cause the one or more processors to perform actions comprising: controlling equipment by preventing operation of the equipment if an actual angle of the equipment relative to level is outside of a slope limit for the equipment.

Example 23. The slope management system, method, or instructions of any preceding or subsequent example or combination of examples, wherein the instructions further comprise instructions which, when executed by the one or more processors, cause the one or more processors to perform actions comprising at least of: receiving the actual angle of the equipment; or determining the actual angle of the equipment.

Example 24. A method of controlling equipment, the method comprising preventing operation of the equipment if an actual angle of the equipment relative to level is outside of a slope limit for the equipment.

Example 25. A slope management system for equipment, wherein the slope management system is configured to: monitor an actual angle of the equipment relative to level; halt, disrupt, and/or prevent further operation of the equipment in a manner increasing the actual angle if the actual angle of the equipment is outside of a slope limit for the equipment.

Example 26. The slope management system, method, or instructions of any preceding or subsequent example or combination of examples, wherein the slope management system is further configured to: enable a corrective operation of the equipment in a manner decreasing the actual angle if the actual angle of the equipment is outside of the slope limit; and enable full operation of the equipment if the actual angle of the equipment is at or within the slope limit.

Example 27. A slope management system comprising: one or more processors; and a non-transitory computer readable storage medium comprising instructions, which, when executed by the one or more processors, cause the one or more processors to perform actions comprising: monitoring an actual angle of the equipment relative to level; and halting, disrupting, and/or preventing further operation of the equipment in a manner increasing the actual angle if the actual angle of the equipment is outside of a slope limit for the equipment.

Example 28. A non-transitory computer readable storage medium comprising instructions executable by one or more processors, the instructions comprising instructions which, when executed by the one or more processors, cause the one or more processors to perform actions comprising: monitoring an actual angle of the equipment relative to level; and halting, disrupting, and/or preventing further operation of the equipment in a manner increasing the actual angle if the actual angle of the equipment is outside of a slope limit for the equipment.

Example 29. A method of controlling equipment, the method comprising: monitoring an actual angle of the equipment relative to level; and halting, disrupting, and/or preventing further operation of the equipment in a manner increasing the actual angle if the actual angle of the equipment is outside of a slope limit for the equipment.

As used herein, the terms “invention,”the invention,“this invention,” and “the present invention” are intended to refer broadly to all of the subject matter of this patent application and the claims below. Statements containing these terms should be understood not to limit the subject matter described herein or to limit the meaning or scope of the patent claims below.

As used herein, the meaning of “a,” “an,” and “the” includes singular and plural references unless the context clearly dictates otherwise.

The elements included in the illustrations herein may not be drawn to scale. For example, figures depicting equipment may include exaggerated features for illustrative purposes.

The subject matter of embodiments of the present disclosure is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Directional references such as “up,” “down” “top” “bottom,” “left,” “right,” “vertical,” “horizontal,” “lateral,” “longitudinal,” “front,” and “back,” among others, are intended to refer to the orientation as illustrated and described in the figure (or figures) to which the components and directions are referencing.

The terms “comprising,” “having,” “including,” and “containing” are to be construed as open-ended terms (i.e., meaning “including, but not limited to,”) unless otherwise noted. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

The above-described aspects are merely possible examples of implementations, merely set forth for a clear understanding of the principles of the present disclosure. Many variations and modifications can be made to the above-described embodiment(s) without departing substantially from the spirit and principles of the present disclosure. All such modifications and variations are intended to be included herein within the scope of the present disclosure, and all possible claims to individual aspects or combinations of elements or steps are intended to be supported by the present disclosure. Moreover, although specific terms are employed herein, as well as in the claims that follow, they are used only in a generic and descriptive sense, and not for the purposes of limiting the described embodiments, nor the claims that follow.

1. A slope management system for equipment, wherein the slope management system is configured to:
receive or determine an actual angle of the equipment relative to level as defined by horizontal ground; and
control the equipment by halting, disrupting, or preventing further operation of the equipment that increases the actual angle of the equipment relative to level responsive to the actual angle of the equipment being outside of a slope limit for the equipment.

2. The slope management system of claim 1, wherein the slope management system further comprises at least one sensor configured to measure or detect the actual angle of the equipment relative to level.

3. The slope management system of claim 1, wherein the slope management system is configured to prevent operation of the equipment if the actual angle of the equipment relative to level is outside of a slope limit for the equipment and is a measured angle of the equipment obtained prior to operation of the equipment.

4. The slope management system of claim 1, wherein the slope management system is configured to receive the actual angle of the equipment from an external source.

5. The slope management system of claim 4, wherein the external source comprises at least one of a sensor on the equipment or another system of the equipment.

6. The slope management system of claim 1, wherein the slope management system is configured to determine the actual angle of the equipment.

7. The slope management system of claim 1, wherein the slope management system is configured to halt, adjust, or prevent further operation of the equipment that increases the actual angle of the equipment by sending a control signal to one or more control devices of the equipment.

8. The slope management system of claim 1, wherein the slope management system is further configured to provide a supplemental output if the actual angle of the equipment relative to level is outside of the slope limit for the equipment, wherein the supplemental output comprises at least one of an alert, an alarm, a light, or a display.

9. Equipment comprising the slope management system of claim 1.

10. The equipment of claim 9, wherein the slope management system is retrofit to the equipment.

11. The equipment of claim 9, wherein the equipment comprises at least one of an aerial device, a dump truck, a crane, a personnel lift, a digger derrick, a tele-handler, a scissor lift, a forklift, a bucket truck, a wood chipper, a brush chipper, a vacuum truck, a directional drill, a bull dozer, a backhoe, a wheeled loader, a tracked loader, a skid steer, a compact track loader, an excavator, a compactor, a steam roller, a motor grader, a chip truck, a tractor, or combinations thereof.

12. The slope management system of claim 1, wherein the slope management system is further configured to:
enable a corrective operation of the equipment that decreases the actual angle responsive to the actual angle of the equipment being outside of the slope limit; and
enable full operation of the equipment responsive to the actual angle of the equipment being at or within the slope limit.

13. A slope management system comprising:
one or more processors; and
a non-transitory computer readable storage medium comprising instructions, which, when executed by the one or more processors, cause the one or more processors to perform actions comprising:
receiving or determining an actual angle of equipment relative to level as defined by horizontal ground; and
controlling the equipment by halting, disrupting, or preventing further operation of the equipment that increases the actual angle of the equipment relative to level responsive to the actual angle of the equipment being outside of a slope limit for the equipment.

14. The slope management system of claim 13, wherein the instructions further comprise instructions, which, when executed by the one or more processors, cause the one or more processors to perform actions comprising:
enabling a corrective operation of the equipment that decreases the actual angle responsive to the actual angle of the equipment being outside of the slope limit; and
enabling full operation of the equipment responsive to the actual angle of the equipment being at or within the slope limit.

15. The slope management system of claim 13, wherein the instructions further comprise instructions, which, when executed by the one or more processors, cause the one or more processors to perform actions comprising at least one of:
receiving the actual angle of the equipment from a sensor; or
determining the actual angle of the equipment based on sensor data.

16. The slope management system of claim 13, wherein the instructions further comprise instructions, which, when executed by the one or more processors, cause the one or more processors to perform actions comprising:
generating a supplemental output if the actual angle of the equipment relative to level is outside of the slope limit for the equipment by generating at least one of an alert, an alarm, a light, or a display as the supplemental output.

17. A non-transitory computer readable storage medium comprising instructions executable by one or more processors, the instructions comprising instructions which, when executed by the one or more processors, cause the one or more processors to perform actions comprising:
receiving or determining an actual angle of equipment relative to level as defined by horizontal ground; and
controlling the equipment by halting, disrupting, or preventing further operation of the equipment that increases the actual angle of the equipment relative to level responsive to the actual angle of the equipment being outside of a slope limit for the equipment.

18. The non-transitory computer readable storage medium of claim 17, wherein the instructions further comprise instructions which, when executed by the one or more processors, cause the one or more processors to perform actions comprising at least one of:
receiving the actual angle of the equipment from a sensor; or
determining the actual angle of the equipment based on sensor data.

19. The non-transitory computer readable storage medium of claim 17, wherein the instructions further comprise instructions which, when executed by the one or more processors, cause the one or more processors to perform actions comprising:
enabling a corrective operation of the equipment that decreases the actual angle responsive to the actual angle of the equipment being outside of the slope limit; and
enabling full operation of the equipment responsive to the actual angle of the equipment being at or within the slope limit.

20. The non-transitory computer readable storage medium of claim 17, wherein the equipment comprises manufacturer-published slope limits or user-defined slope limits.
